(19) United States
(12) Patent Application Publication
(10) Pub. No.: US 2006/0094819 A1
(43) Pub. Date: May 4, 2006

(54) Low-viscosity, radiation-curable urethane binder dispersions with high solids contents

(76) Inventors: Manfred Muller, Monchengladbach (DE); Richard Kopp, Koln (DE); Wolfgang Fischer, Meerbusch (DE); Jan Weikard, Odenthal (DE)

Correspondence Address: BAYER MATERIAL SCIENCE LLC, 100 BAYER ROAD, PITTSBURGH, PA, 15205, US

(21) Appl. No.: 11/264,078

(22) Filed: Nov. 1, 2005

(30) Foreign Application Priority Data
Nov. 4, 2004 (DE) 102004053186.2

(51) Int. Cl. C08G 18/08

(52) U.S. Cl. 524/589

(57) ABSTRACT

The present invention relates to water-free and cosolvent-free binder compositions A) containing of a mixture of A1) at least one emulsifier-free, hydrophobic binder containing groups which can be polymerized by high-energy radiation and A2) at least one hydrophilic unsaturated polyester resin containing the reaction product of a) at least one unsaturated dicarboxylic acid and/or an anhydride thereof, b) at least one polyalkylene oxide compound having a number average molecular weight of 106 to 2000, at least 2 hydroxyl end groups and at least 2 oxyalkylene units, wherein at least 50% of the oxyalkylene units are oxyethylene units, and c) at least one hydroxy-functional compound containing at least one polymerizable unsaturated group per molecule selected from vinyl, allyl, methacrylic and acrylic groups. The present invention also relates to aqueous dispersions containing the binder compositions A), to a process for preparing an aqueous dispersion containing the binder dispersion, to a process for diluting the binder composition with tap water, to producing coatings from the aqueous dispersions and to the use of the binder compositions for preparing coating, adhesive or sealant compositions.

### BACKGROUND OF THE INVENTION

1. Field of the Invention

The present invention relates to radiation-curable urethane binder dispersions having high solids contents in combination with low processing viscosities and to aqueous dispersions containing these binder compositions.

2. Description of Related Art

The preparation of aqueous polyurethane dispersions is known and is described extensively in the patent literature and in standard works. Following application to the substrate and the evaporation of the water, the dispersions are generally crosslinked at relatively high temperatures and/or with special curatives, although this restricts the possibilities for use. These restrictions can be circumvented through the use of radiation-crosslinkable urethane dispersions.

One way of preparing solvent-free, radiation-curable, aqueous binder dispersions is to use a combination of a radiation-curable binder and a radiation-curable emulsifier. Hydrophilic modification of the emulsifier is achieved through the incorporation of segments containing ionic centres, especially sulphonate or carboxylate salt groups, or hydrophilic nonionic segments, such as polyoxyethylene segments. Further products are described, for example, in EP-A 0 584 734. In the examples, dispersions having solids contents of up to 62% are prepared.

Aqueous dispersions based on water-dispersible, radiation-curable polyurethane acrylates, their preparation and use are disclosed in EP-A 0 753 531. With that process it is possible to prepare dispersions having an outstanding profile of properties and having solids contents of up to a maximum of 60% by weight. It is possible to tailor the properties to the requirements by a selection of the binder's synthesis components.

In all of the known processes, however, for practical handling, and in particular in relation to the viscosity of the formulations, there are limits on the solids content; the dispersions generally have a maximum solids content of about 50% to 65% by weight. It is desirable to have dispersions having an even higher solids content, since by virtue of a higher solids content it is possible to reduce the costs for production, storage, transit and application and the time required for the removal of the water following application. Particularly desirable from the standpoint of the user is a water-free and cosolvent-free formulation (100% as-supplied form) which can be mixed on site with the amount of water needed to establish a desired viscosity, and then processed.

An object of the present invention is to provide low-viscosity, aqueous, UV-curing coating compositions having a solids content of up to 90% by weight or more, and to provide binders which are correspondingly water-dilutable on site. The highly concentrated dispersions should also exhibit high stability on storage, in order to ensure a sufficient storage life and processing life.

This object may be achieved with a specific combination of two unsaturated binders. The binder combinations of the present invention have a very high reactivity and, after curing, lead to haze-free films having good adhesion, low yellowing, good mechanical and chemical resistance and good scratch resistance, in particular an improved resistance to butter, oil and paraffins.

### SUMMARY OF THE INVENTION

The present invention relates to water-free and cosolvent-free binder compositions A) containing of a mixture of
A1) at least one emulsifier-free, hydrophobic binder containing groups which can be polymerized by high-energy radiation and
A2) at least one hydrophilic unsaturated polyester resin containing the reaction product of
   a) at least one unsaturated dicarboxylic acid and/or an anhydride thereof,
   b) at least one polyalkylene oxide compound having a number average molecular weight of 106 to 2000, at least 2 hydroxyl end groups and at least 2 oxyalkylene units, wherein at least 50% of the oxyalkylene units are oxyethylene units, and
   c) at least one hydroxy-functional compound containing at least one polymerizable unsaturated group per molecule selected from vinyl, allyl, methacrylic and acrylic groups.

The present invention also relates to aqueous dispersions containing the binder compositions A), to a process for preparing an aqueous dispersion containing the binder dispersion, to a process for diluting the binder composition with tap water, to producing coatings from the aqueous dispersions and to the use of the binder compositions for preparing coating, adhesive or sealant compositions.

### DETAILED DESCRIPTION OF THE INVENTION

Together with component A1) it is also possible to use known reactive diluents, such as dipropylene glycol diacrylate, hexanediol diacrylate, isobornyl acrylate or trimethylolpropane triacrylate.

Components A1) and A2) are used in a weight ratio of 90:10 to 50:50, preferably 90:10 to 60:40 and more preferably 85:15 to 75:25.

100 parts by weight of the aqueous dispersions of the invention contain at least 10 parts, preferably at least 40 parts and more preferably at least 60 parts by weight of radiation-curable binder compositions A). Optionally it is possible to add to 100 parts by weight of the aqueous dispersion, up to 200 parts by weight of known additives B), such as blocking agents, thickeners, initiators, pigments, fillers or matting agents, and up to 30 parts by weight of at least one polar, water-miscible solvent C).

The emulsifier-free, hydrophobic unsaturated binder A1) preferably contains at least one urethane acrylate. “Hydrophobic” in accordance with the present invention means that without the addition of an emulsifier, component A1) cannot be stably dispersed in water in a concentration of more than 20% by weight.

Urethane acrylate A1) is prepared by esterifying
d) at least one difunctional hydroxy compound having at least 2 incorporated oxyethylene groups per molecule with
e) a less that equivalent amount, based on the hydroxyl groups of d), of acrylic acid and/or methacrylic acid and subsequently reacting the remaining hydroxyl groups with
f) at least one polyisocyanate having (cyclo)aliphatically-bound isocyanate groups.

Urethane acrylate A1) is prepared using d) hydroxy compounds having at least 2 incorporated oxyethylene groups per molecule. These compounds are known and may be obtained by reacting dihydroxy compounds (such as glycols, e.g., ethylene glycol, diethylene glycol, triethylene glycol, propylene glycol or butane-1,4-diol) or polyhydroxy compounds (such as trimethylolpropane or glycerol) with at least 2 moles of ethylene oxide per mole of hydroxy compound.

Adducts of 1 mole of trimethylolpropane and 2 to 15 moles of ethylene oxide are preferably used as d). Mixtures of these compounds can also be used. Particularly preferred are adducts of trimethylolpropane and 3 to 6 moles of ethylene oxide. Hydroxy compounds d) are esterified with an unsaturated monocarboxylic acid e), preferably acrylic acid or methacrylic acid, more preferably acrylic acid. In this reaction only 50% to 95%, preferably 70% to 90% and more preferably 80% to 90% of the hydroxyl groups in hydroxy compounds d) are esterified.

The remaining free hydroxyl groups are subsequently reacted with at least one polyisocyanate f) having (cyclo)aliphatically-bound isocyanate groups, so that two or more of the partially acrylated hydroxy compounds are joined to one another via urethane groups.

Suitable di- and polyisocyanates f) include polyisocyanates having aliphatically- or cycloaliphatically-bound isocyanate groups. Mixtures of these polyisocyanates can also be used. Examples of suitable polyisocyanates include butylene diisocyanate, hexamethylene diisocyanate (HDI), isophorone diisocyanate (IPDI), 2,2,4- and/or 2,4,4-trimethylhexamethylene diisocyanate, the isomeric bis(4,4′-isocyanatocyclo-hexyl)methanes or mixtures thereof of any desired isomer content, isocyanatomethyl-1,8-octane diisocyanate, 1,4-cyclohexylene diisocyanate, derivatives of these monomeric polyisocyanates having urethane, isocyanurate, allophanate, biuret, uretdione or iminooxadiazinedione groups, and mixtures thereof. Preferred are hexamethylene diisocyanate, isophorone diisocyanate, the isomeric bis(4,4′-isocyanatocyclohexyl)methanes and mixtures thereof.

The equivalent ratio of the isocyanate groups to the free hydroxyl groups is preferably 1:0.9 to 1:1.1, more preferably 1:0.95 to 1:1.05.

The reaction between the isocyanate component and the hydroxy compound is preferably catalyzed with small amounts of a known urethane catalyst. Suitable catalysts include tertiary amines, tin compounds, zinc compounds or bismuth compounds, especially triethylamine, 1,4-diazabicyclo[2.2.2]octane, tin dioctoate or dibutyltin dilaurate. The amount of the catalyst can be adapted to the requirements of the reaction. Suitable amounts are 0.01% to 2%, preferably 0.05% to 1% and more preferably 0.07% to 0.6% by weight, based on the weight of the reaction mixture.

If the resulting urethane acrylate A1) is stored for a relatively long time it is preferred to admix it with a stabilizer for preventing premature polymerization, such as 2,6-di-t-butyl-4-methylphenol, for example.

To prepare the unsaturated polyester A2), which has an emulsifying action, unsaturated dicarboxylic acids a) or their anhydrides or their diesters with low molecular weight alcohols (preferred is maleic anhydride) are reacted with polyhydroxy compounds b) which contain at least 50%, preferably 70%, more preferably 90% of oxyethylene units (based on the total number of oxyalkylene units present) and have a number average molecular weight, Mₙ, of 106 to 2000, preferably 200 to 1000 and more preferably 200 to 500. Preferred compounds b) are medium to long chain polyethylene glycols having number average molecular weights of 200 to 1000, preferably 200 to 500.

Optionally compounds b) contain up to 10 parts of weight propylene glycole.

The equivalent ratio of unsaturated dicarboxylic acids (anhydrides) a) to polyhydroxy compounds b) is selected such that the polymer chains formed have carboxyl end groups.

These free carboxyl groups are esterified with monohydroxy-functional compounds c) having at least one polymerizable unsaturated group per molecule, such as trimethylolpropane diallyl ether, hydroxyethyl acrylate, hydroxypropyl acrylate, hydroxybutyl acrylate, trimethylolpropane diacrylate, glyceryl monoacrylate monomethacrylate or reaction products thereof with caprolactone, for example. Preferred are trimethylolpropane diallyl ether, trimethylolpropane diacrylate and hydroxyethyl acrylate; especially preferred is trimethylolpropane diallyl ether.

The present invention also relates to a process for preparing an aqueous dispersion containing the binder composition of the invention by diluting the binder composition with water until the desired viscosity is obtained.

The present invention also relates to a process for diluting the binder composition of the invention with water, characterized in that initially a 70% dispersion of the binder composition of the invention in water is prepared by adding 30 parts by weight of water, such as tap water, to 70 parts by weight of binder composition A), i.e., the mixture of A1) and A2), with slow stirring, and then emulsifying the mixture by means of a dissolver at high speed (peripheral stirrer-disc speed: about 20 m/sec) for 2 minutes. At a reduced speed the aqueous constituents are added. This concentrated dispersion can then be diluted to the desired solids content by the addition of the remaining water, such as tap water.

In the case of direct further processing the water can also be added on site with simple stirring.

When the solids content is to be greater than 70%, the binder composition of the invention is prepared directly in the desired mixing ratio and mixed by the procedure described above.

Non-aqueous additives must be dispersed in the mixture of A1) and A2) before they are emulsified.

Pigmented paints should be dispersed, depending on the degree of pigmentation/level of filling, either in the resin or after a stock emulsion (about 75%) has been prepared beforehand using a dissolver. In the case of dispersion in the resin it is necessary to cool the millbase to 35° C. prior to emulsification.

UV curing necessitates liquid initiators, which are added to the resin prior to emulsification. Prior to radiation curing it is necessary for the water to have evaporated completely.

The present invention also relates to a process for producing coatings by applying an aqueous dispersion containing the binder compositions of the invention to a substrate, removing the water and then curing the coating composition.

The coating compositions of the invention can be applied by known techniques to a variety of different substrates by spraying, rolling, knife coating, casting, squirting, brushing or dipping, for example. Substrates are selected from wood, metal, plastic, paper, leather, textiles, felt, glass or mineral substrates. Preferred substrates are wood and plastics.

The applied film thicknesses (before curing) are typically between 0.5 and 1000 μm, preferably between 5 and 500 μm and more preferably between 15 and 200 μm.

Curing can take place thermally or by exposure to high-energy radiation. Curing preferably takes place by exposure to high-energy radiation, i.e., UV radiation or daylight, e.g., light with a wavelength of 200 to 700 nm, or by bombardment with high-energy electrons (electron beams, 150 to 300 keV). Radiation sources for light or UV light that are used include high pressure or medium pressure mercury vapor lamps. The mercury vapor may be modified by doping with other elements such as gallium or iron. Lasers, pulsed lamps (known under the designation UV flashlight lamps), halogen lamps or excimer emitters are also suitable. The sources may be fitted with filters which prevent the emission of a part of the source's spectrum. For reasons of occupational hygiene the radiation assigned to the UV-C or UV-C and UV-B may be filtered out. The sources may be installed in a stationary manner, so that the material to be irradiated is conveyed past the radiation source by means of a mechanical device, or the sources may be mobile and the material to be irradiated may remain stationary in the course of curing. The radiation dose which is normally sufficient for crosslinking in the case of UV curing is 80 to 5000 mJ/cm².

Irradiation may also be carried out in the absence of oxygen, such as under an inert gas atmosphere or oxygen-reduced atmosphere. Suitable inert gases are preferably nitrogen, carbon dioxide, noble gases or combustion gases. Irradiation may additionally take place with the coating covered with media that are transparent for the radiation. Examples of such media include polymeric films, glass or liquids such as water.

Depending on the radiation dose and the curing conditions, the nature and concentration of any initiator used can be varied in known manner.

It is preferred to carry out curing using high-pressure mercury lamps in stationary installations. Photoinitiators are then employed at concentrations of 0.1% to 10%, more preferably 0.2% to 3.0% by weight, based on the solids content of the coating composition. For curing these coatings it is preferred to use a dose of from 200 to 3000 mJ/cm², measured in the wavelength range from 200 to 600 nm.

Initiators which can be employed for free-radical polymerization, as component B), include radiation-activable initiators and/or thermally activable initiators. Photoinitiators which are activated by UV or visible light are preferred in this context. Photoinitiators are known and include unimolecular (type I) and bimolecular (type II) initiators. Suitable (type I) systems are aromatic ketone compounds, e.g. benzophenones in combination with tertiary amines, alkylbenzophenones, 4,4′-bis(dimethylamino)benzophenone (Michler's ketone), anthrone and halogenated benzophenones or mixtures thereof. Suitable (type II) initiators include benzoin and its derivatives, benzil ketals, acylphosphine oxides (e.g. 2,4,6-trimethylbenzoyldiphenylphosphine oxide and bisacylphosphine oxides), phenylglyoxylic esters, camphorquinone, α-aminoalkylphenones, α,α-dialkoxyacetophenones and α-hydroxyalkylphenones. Preferred photoinitiators are those which can be readily incorporated into aqueous coating compositions. Examples of such products include Irgacure® 500, Irgacure® 819 DW (Ciba, Lampertheim, DE) and Esacure® KIP (Lamberti, Aldizzate, Italy). Mixtures of these compounds can also be used.

Thermal initiators include peroxy compounds such as diacyl peroxides (e.g. benzoyl peroxide), alkyl hydroperoxide such as diisopropylbenzene monohydroperoxide, alkyl peresters such as tert-butyl perbenzoate, dialkyl peroxides such as di-tert-butyl peroxide, peroxydicarbonates such as dicetyl peroxide dicarbonate, inorganic peroxides such as ammonium peroxodisulphate or potassium peroxodisulphate. Also suitable are azo compounds such as 2,2′-azobis [N-(2-propenyl)-2-methylpropionamide], 1-[(cyano-1-methylethyl)azo]-form amide, 2,2″azobis(N-butyl-2-methylpropionamide), 2,2′-azobis(N-cyclo-hexyl-2-methylpropionamide), 2,2′-azobis {2-methyl-N-[2-(1-hydroxybutyl)]-propionamide}, 2,2′-azobis {2-methyl-N-[2-(1-hydroxybutyl)]propionamide, 2,2′-azobis {2-methyl-N-[1,1-bis(hydroxymethyl)-2-hydroxyethyl]propionamide, and benzpinacol. Preferred compounds are those which are soluble in water or present in the form of aqueous emulsions. These free-radical initiators may be combined in known manner with accelerators.

Examples of additives B) include barrier agents, such as waxes, preferably paraffins having a melting point between 35° C. and 100° C., preferably 40° C. to 80° C. They are added preferably in the form of aqueous dispersions to the binder dispersions. They accumulate at the air/aqueous dispersion interface and thus prevent the inhibition of polymerization by atmospheric oxygen.

Other suitable additives B) are known and include stabilizers, light stabilizers such as UV absorbers and sterically hindered amines (HALS, hindered amine light stabilizers), antioxidants, fillers, anti-settling agents, defoaming and/or wetting agents, flow control agents, plasticizers, catalysts, solvents, thickeners, pigments, dyes and/or matting agents.

Water-miscible, polar solvents are used as component C). Suitable water-dilutable solvents include low molecular weight alcohols such as ethanol and isopropanol or low molecular weight ketones such as acetone or butanone (methyl ethyl ketone).

Through the addition of these solvents in amounts of not more than 10%, preferably not more than 5% and more preferably less than 2%, based on the weight of the aqueous dispersion, the viscosity of the dispersions is shifted in the field of high solids contents to lower values. This means that the phase inversion point is shifted to lower solids contents, i.e., for a given, high solids content, the viscosity is substantially reduced.

The aqueous binder dispersions containing the binder compositions of the invention can be readily combined with other binders such as polyurethane dispersions or polyacrylate dispersions, which may also be hydroxy-functional.

The present invention also relates to the use of the binder compositions of the invention for preparing coating, adhesive or sealant compositions. Preferred is their use for coating wood, such as in furniture coating or woodblock-floor coating.

The binder compositions of the invention contain virtually no volatile fractions. They can be used preferentially as UV-curing reaction components, for example for solvent-free and amine-free, water-based paints and varnishes, both clear and pigmented, glossy and matt. The coatings produced therefrom are bright, scratch-resistant and resistant to water, alcohol, solvents and household chemicals.

The following examples and comparison examples are intended to illustrate the invention without restricting its scope. All quantities in “parts” and “%” are by weight unless otherwise indicated.

### EXAMPLES

### Example 1

### Preparation of Urethane Acrylate A1)

4905.04 parts by weight of an adduct of 1 mole of trimethylolpropane and 3.9 moles of ethylene oxide that was esterified with 2.6 moles of acrylic acid were admixed with 5.40 parts by weight of Desmorapid® Z (dibutyltin dilaurate from Bayer AG, DE) and 5.40 parts by weight of 2,6-di-t-butyl-4-methylphenol, as inhibitor, and this mixture was heated to 60° C., during which air was passed through it. Then 494.96 parts by weight of isophorone diisocyanate were added dropwise, the internal temperature was maintained at 60° C. by means of external cooling. Stirring was continued until an NCO content of <0.1% by weight was reached.

### Example 2

### Preparation of the Unsaturated Polyester A2)

Quantities Employed:

397.26 g polyethylene glycol 400
91.86 g trimethylolpropane diallyl ether
105.20 g maleic anhydride
   toluhydroquinone paste: 0.03% based on batch size (toluhydroquinone or 2-methylhydroquinone or 2,5-dihydroxytoluene)
      Experimental Procedure:

Polyethylene glycol, maleic anhydride and toluhydroquinone paste were heated to 150° C. in about 1 hour, utilizing the heat from the exothermic reaction, in a 1 liter three-necked flask and were held at 150° C. for 3 hours, during which nitrogen was passed through the flask continually at a rate of one flask volume per hour. Thereafter the mixture was cooled to 130° C., during which nitrogen was passed through the mixture at a rate of two flask volumes per hour and, with the passage of nitrogen being continued, trimethylolpropane diallyl ether was added. The mixture was then heated in stages to 180° C. over 4 hours (150, 160, 170, 180° C.), and at 180° C. the temperature was maintained until a viscosity (75% in styrene) of 30 to 35″ was reached.

The mixture was cooled to 160° C. and held at this temperature until a viscosity, 75% in styrene, of 40 to 45″ was reached (target value: 43″; acid number 25-15).

Finally the product was cooled to ≦80° C. and dispensed.

### Example 3

### Preparation of a 70%, Dilutable Aqueous Dispersion from a Mixture Of Urethane Acrylate A1) from Example 1 and Unsaturated Polyester A2) from Example 2

70 parts by weight of a mixture of 20 parts by weight of the emulsifier from Example 2 and 80 parts by weight of the urethane acrylate from Example 1 were introduced into a vessel, 30 parts by weight of tap water were added with slow stirring, and then the mixture was emulsified by means of a dissolver at high speed (peripheral stirrer-disc speed: 20 m/sec) for about 2 minutes. At a reduced speed the remaining, aqueous constituents of the formula are added. Depending on the formula employed, the blend may have a limited storage stability. Over the course of this time it can be diluted to the desired solids content by adding further water.

Where the solids content is to be higher than 70%, the mixture can be made up directly in the desired mixing ratio and mixing can take place by the procedure described above.

### Example 4

### Dilution Behavior with Water

When different amounts of water were added to aqueous dispersions of the 80:20 mixture of urethane acrylate and emulsifying resin, using the method described in Example 3, the resulting dispersions featured increasing viscosity for increasing solids content, with a maximum of about 10,000 mPas (phase-inversion point) at about 80% by weight solids/20% by weight water (25° C.). After this point the viscosity fell off again until it reached a range <1000 mPas at 90% by weight solids.

TABLE 1
Dilution behavior of a resin mixture of 80% by weight of urethane acrylate
(Example 1) and 20% by weight of emulsifier resin (Example 2)

| | | | | | | | | | | | |
|---|---|---|---|---|---|---|---|---|---|---|---|
| Solids content [wt %] | 100 | 95 | 90 | 85 | 80 | 75 | 70 | 65 | 60 | 55 | 50 |
| Water content [wt %] | 0 | 5 | 10 | 15 | 20 | 25 | 30 | 35 | 40 | 45 | 50 |

Viscosity at 23° C. [mPaS]

| | | | | | | | | | | | |
|---|---|---|---|---|---|---|---|---|---|---|---|
| Resin supply form | 1900 | 800 | 900 | 6000 | 10,000 | 6500 | 1500 | 200 | 100 | <20 | <20 |
| Resin supply form + 2% acetone | 1900 | 1100 | 600 | 100 | 400 | 4000 | 7000 | 4000 | 300 | <20 | <20 |
| Resin supply form + 2% ethanol | 1900 | 1100 | 700 | 200 | 600 | 2700 | 4500 | 2700 | 200 | <20 | <20 |

By adding 2% by weight of ethanol or 2% by weight of acetone it was possible to lower the phase-inversion point in the level of the viscosity and to shift it to lower solids contents/higher water contents, so that even in the range of a solids content of about 80% to >90% by weight a low-viscosity range developed which was particularly suitable for processing.

Furthermore, even without the addition of solvent, the viscosity was within a range which was suitable for processing for solids concentrations of up to about 70% by weight.

Depending on the viscosity of the formulations it is possible to use application methods such as rolling, spraying or casting.

### Example 5

### Solubility of the Urethane Acrylate of Example 1 in Fully Deionized Water and Tap Water

100 parts by weight of the urethane acrylate from Example 1 were shaken intensively in a separating funnel in 100 parts by weight of water. Following phase separation, both phases were analyzed for their water content (Karl-Fischer titration). The results obtained are as follows:

TABLE 2

| | % water in | % water in |
|---|---|---|
| Type of water | organic phase | aqueous phase |
| fully deionized water | 4.0 | 100.1 |
| tap water | 3.4 | 100.5 |

The water levels of the aqueous phase (>100%) were caused by the inaccuracy of Karl-Fischer titration, which increased at relatively high water levels.

The experiment shows that the urethane acrylate of Example 1 was virtually insoluble in water. The urethane acrylate itself can take up a small amount of water, but this phase was not homogeneous (clouding).

### Example 6

### Use Example—Preparation of a Clear, Matt Roller Coating

The resin mixture obtained from Example 3, containing a urethane acrylate and emulsifier (100 parts by weight thereof), was admixed with 2 parts by weight each of matting agents (Deuteron® MK, Schoner, Achim-Uphusen and Gasil® EBN, Omya DE) and 3 parts of Esacure® KIP 100F (Fratelli Lamberti, Italy), with stirring. This was followed by emulsification and further dilution as described in Example 3, using 43 parts and 11 part of tap water. The viscosity of the 65% coating composition amounted to approximately 2200 mPa·s/23° C. After overnight storage (aging) this paint was applied at about 15 g/m² to preimpregnated film, flashed off at 60° C. for about 1 minute and cured at a belt speed of 7 m/min/80 W lamp (or more quickly by a multiple factor under inert gas). The result was a scratch-resistant, stable, silk-sheen coating.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A water-free and cosolvent-free binder composition A) comprising a mixture of
A1) at least one emulsifier-free, hydrophobic binder containing groups which can be polymerized by high-energy radiation and
A2) at least one hydrophilic unsaturated polyester resin containing the reaction product of
a) at least one unsaturated dicarboxylic acid and/or an anhydride thereof,
b) at least one polyalkylene oxide compound having a number average molecular weight of 106 to 2000, at least 2 hydroxyl end groups and at least 2 oxyalkylene units, wherein at least 50% of the oxyalkylene units are oxyethylene units, and
c) at least one hydroxy-functional compound containing at least one polymerizable unsaturated group per molecule comprising a member selected from the group consisting of vinyl, allyl, methacrylic and acrylic groups.

2. The water-free and cosolvent-free binder composition of claim 1 wherein component A1) comprises a urethane acrylate.

3. The water-free and cosolvent-free binder composition of claim 1 wherein the urethane acrylate A1) is the reaction product of
d) at least one difunctional hydroxy compound having at least 2 incorporated oxyethylene groups per molecule,
e) acrylic acid and/or methacrylic acid and
f) at least one polyisocyanate having (cyclo)aliphatically-bound isocyanate groups.

4. The water-free and cosolvent-free binder composition of claim 1 wherein urethane acrylate A1) and/or polyester resin A2) contain an inhibitor for preventing premature polymerization.

5. The water-free and cosolvent-free binder composition of claim 4 wherein the inhibitor comprises 2,6-di-t-butyl-4-methylphenol.

6. An aqueous dispersion containing the binder composition A) of claim 1.

7. A process for preparing an aqueous dispersion which comprises diluting the binder composition of claim 1 with water until the desired viscosity is obtained.

8. A process for preparing an aqueous dispersion which comprises adding 30 parts of tap water to 70 parts by weight of the binder composition of claim 1 with slow stirring and then emulsifying the mixture.

9. A process for preparing a coating which comprises applying the aqueous dispersion of claim 6 to a substrate, removing the water and then curing the coating.

10. The process of claim 9 wherein the substrate is wood.

11. The process of claim 9 which comprises curing the coating by exposure to high-energy radiation.

12. A coating, adhesive or sealant composition containing the binder composition of claim 1.
